(19) United States
(12) Patent Application Publication
(10) Pub. No.: US 2005/0115836 A1
(43) Pub. Date: Jun. 2, 2005

(54) Hydrophobic surface provided with a multitude of electrodes

(76) Inventor: Karsten Reihs, Koln (DE)

Correspondence Address: PERMAN & GREEN, 425 POST ROAD, FAIRFIELD, CT, 06824, US

(21) Appl. No.: 10/499,605

(22) PCT Filed: Dec. 17, 2002
(86) PCT No.: PCT/EP02/14394

(30) Foreign Application Priority Data
Dec. 17, 2001 (DE) 101 62 064.4

(51) Int. Cl. G01N 27/453

(52) U.S. Cl. 204/450; 204/600

(57) ABSTRACT

The invention relates to a supporting plate and/or analysis plate for accommodating the smallest drops of liquid, having an ultraphobic surface, which is open at the top, and having a grid of electrodes that are, in essence, uniformly distributed. These electrodes, while being situated underneath the ultraphobic surface, each enable an electrical field to be generated.

The present invention relates to a storage plate and/or analysis plate for minuscule fluid drops which comprises an open-top ultraphobic surface and a grid of substantially uniformly distributed electrodes with which an electric field may in each case be generated and which are arranged beneath the ultraphobic surface.

The present invention furthermore relates to a method for setting down fluid drops, a method for locating fluid drops, a method for minimising fluid losses and mass transport phenomena, a method for determining the size of a fluid drop and the use of ultraphobic surfaces for reducing fluid losses and mass transport phenomena.

Automated chemical and/or biological analysis of a plurality of minuscule fluid drops, which have a volume of the order of magnitude of 10⁻¹² to 10⁻⁶ litres or a diameter of the order of magnitude of approx. 0.01 to 1 mm, is becoming increasing significant in biotechnology. During analysis, the fluid drop is preferably stored in air, such that its consistency is not modified by mass transfer with surfaces on which it rests. Such air storage is, however, very difficult and costly to achieve.

The object of the present invention was accordingly to provide an apparatus which does not exhibit the disadvantages of the prior art.

The object is achieved by a storage plate and/or analysis plate for minuscule fluid drops which comprises an open-top ultraphobic surface and a grid of substantially uniformly distributed electrodes with which an electric field may in each case be generated and which are arranged beneath the ultraphobic surface.

For the person skilled in the art, it was utterly surprising and unexpected that it should be possible using the storage plate according to the invention to store and analyse minuscule fluid drops without there being any appreciable mass transfer between the fluid drop and the ultraphobic surface. The fluid drops may be stored at a precisely defined location and it is accordingly straightforward for an analytical instrument to be directed towards them. The apparatus according to the invention is simple and economic to manufacture.

A liquid drop for the purposes of the invention consists of any desired liquid and preferably exhibits a volume of 10⁻¹² to 10⁻⁶ litres, particularly preferably of 10⁻⁹ to 10⁻⁵ litres.

According to the invention, the apparatus has an open-top, ultraphobic surface. An ultraphobic surface for the purposes of the invention is distinguished in that the contact angle of a water drop lying on the surface is more than 150° and the roll-off angle does not exceed 10°. The roll-off angle is taken to mean the angle of inclination of a basically planar but textured surface relative to horizontal at which a stationary water drop with a volume of 10 μl is set in motion by gravity when the surface is inclined. Such ultraphobic surfaces are, for example, disclosed in WO 98/23549, WO 96/04123, WO 96/21523, WO 00/39369, WO 00/39368, WO 00/39239, WO 00/39051, WO 00/38845 and WO 96/34697, which are hereby introduced as references and are accordingly deemed to be part of the disclosure.

In a preferred embodiment, the ultraphobic surface has a surface topography in which the spatial frequency f of the individual Fourier components and their amplitudes a(f) expressed by the integral S(log f)=a(f)·f, calculated between the integration limits log (f₁/μm⁻¹)=−3 and log (f₁/μm⁻¹)=3, is at least 0.3 and which consists of a hydrophobic or in particular oleophobic material or of a durably hydrophobised or in particular durably oleophobised material. Such an ultraphobic surface is described in international patent application WO 00/39240, which is hereby introduced as a reference and is accordingly deemed to be part of the disclosure.

The apparatus according to the invention furthermore comprises a grid with substantially uniformly distributed electrodes, with which an electric field may in each case be generated. The grid preferably comprises at least 16×16=256, particularly preferably at least 64×64=4096 and very particularly preferably at least 256×256=65536 electrodes. The electrodes are in each case individually connectable to an electrical voltage source of preferably 10 to 1000 V, particularly preferably of 100 to 300 V, such that an electric field may be generated with each electrode independently of the other electrodes. The electrodes are preferably arranged at a spacing of <100 μm, particularly preferably of <50 μm and highly preferably of <10 μm and preferably have a dimension of <150 μm, particularly preferably of <70 μm and very particularly preferably of <20 μm.

The voltage source is preferably controlled by an automated control unit, for example a computer, and the individual electrodes are thus individually supplied with electrical voltage. The computer establishes which electrode is supplied with electrical voltage at which instant and for how long. In this manner, it is possible to establish the location at which a fluid drop is set down. Actuation of the electrodes by the automated control unit may be modified at any time.

In a preferred embodiment of the present invention, not just one but preferably several electrodes, preferably at least two, particularly preferably at least four electrodes, are actuated simultaneously. When two electrodes are actuated, they are preferably adjacent to one another and when four electrodes are actuated they are preferably arranged in a square.

According to the invention, the electrode grid is arranged beneath the ultraphobic surface. The ultraphobic surface is preferably adhesively bonded over the electrode grid as a film. This embodiment has the advantage that the film can be changed without having to replace the support and the electrodes or to clean the surface.

In a preferred embodiment of the present invention, the apparatus comprises a removable lid, such that losses of the fluid drops located on the ultraphobic surface are reduced. The apparatus preferably additionally comprises a fluid reservoir which is preferably filled with a liquid which is as similar as possible to the fluid of the fluid drops located on the ultraphobic surface. This preferred embodiment of the present invention ensures that evaporative losses of the fluid drops are virtually eliminated.

The present invention also provides a method for setting down fluid drops with the storage plate according to the invention, in which:
an electric field is generated with at least one electrode,
in each case a fluid drop is deposited on the ultraphobic surface and
the fluid drop is immobilised by the electric field.

By means of the method according to the invention, it is possible durably but reversibly to store a plurality of minuscule fluid drops on an apparatus with an ultraphobic surface, for example for automated analysis or also merely for storage purposes. The fluid drops are located at an unambiguously defined point, such that it is entirely straightforward, for example for an analytical apparatus, to be directed towards the fluid drops and to take samples or to analyse them contactlessly.

In a preferred embodiment of the method according to the invention, the drop is dispensed by a metering pump onto the ultraphobic surface and attracted by the electric field which has been generated by at least one electrode of the grid.

Preferably, two or more fluid drops are set down each at different points on the ultraphobic surface.

Before and/or after being set down, the fluid drops are mixed, purified, combined and/or divided. The fluid drops are furthermore preferably evaporated.

The present invention also provides a method for minimising mass transport phenomena in a fluid drop which is moved and/or stored on a surface, in which the surface energy between the surface and the fluid drop is minimised.

The fluid drop is preferably stored on an ultraphobic surface.

This method has the advantage that minuscule fluid drops are not influenced by their environment, which results in distortion of analyses.

The present invention also provides a method for locating fluid drops with the apparatus according to the invention in which the electrical voltage between in each case two electrodes in the vicinity of the fluid drop is modified, preferably periodically, and the variable change in current and the phase shift between the periodic current change and the voltage change is measured. In those electrodes which are located in the immediate vicinity of a fluid drop, the current will be higher than in the other electrodes, such that it is possible on the basis of these measurements to determine the precise location of a fluid drop. The person skilled in the art will recognise that the finer is the electrode grid, the greater will be the accuracy of locating the fluid drop.

Due to the accurate determination of the coordinates of the fluid drop, analytical instruments may be positioned rapidly and accurately thereover or, if fluid drops are to be combined, a second drop may be moved to precisely the position of the first drop.

The present invention also provides a further method for locating fluid drops on a surface, in which light is emitted from a light source and the position of the fluid drop is determined on the basis of the reflected portions of the light. The light sources preferably comprise light guides, preferably of a diameter of <1000 μm, preferably of <100 μm, which are arranged in a regular grid and illuminate the drops on the surface. The reflected portions of the light are also determined by the same light guides.

Due to the accurate determination of the position of the fluid drop, analytical instruments may be positioned rapidly and accurately thereover or, if fluid drops are to be combined, a second drop may be moved to precisely the position of the first drop.

The present invention also provides a method for locating fluid drops which is a combination of the two above-stated methods for locating fluid drops.

The position of the fluid drop is preferably additionally also determined by an optical microscope.

Due to the accurate determination of the position of the fluid drop, analytical instruments may be positioned rapidly and accurately thereover or, if fluid drops are to be combined, a second drop may be moved to precisely the position of the first drop.

The present invention additionally provides a method for determining the size of a fluid drop with the apparatus according to the invention, in which the electrical voltage between in each case two electrodes close to the fluid drop is modified, preferably periodically, and the change in current is measured. The magnitude of the change in current between the pairs of in each case two electrodes, and the phase shift between the periodic voltage change and current change, is a measure of the size of the drop, as the greater is the volume of the fluid drop lying between the electrodes during the measurement, the greater is the current.

Using the method according to the invention, it is possible accurately to determine the size and thus the volume of a drop. This may be of great significance for evaluation of an analysis or for mixing of two or more drops in a very specific ratio.

The present invention also provides another method for determining the size of a fluid drop with a light source, in which light is emitted from at least one light source and the size of the fluid drop is determined on the basis of the reflected portions. To this end a fluid drop, the position of which is known, is illuminated with a light source, preferably a light guide. On the basis of the intensity of the reflected light, which is preferably determined by the same light guides, and by comparative measurements with fluid drops of a known volume, it is possible to ascertain the size of the drop.

Using the method according to the invention, it is possible accurately to determine the size and thus the volume of a drop. This may be of great significance for evaluation of an analysis or for mixing of two or more drops in a very specific ratio.

The present invention also provides a process for determining the size of a fluid drop on a surface, which is a combination of the two above-stated methods.

In the method according to the invention, the size of a drop is preferably additionally determined by an optical microscope.

Using the method according to the invention, it is possible accurately to determine the size and thus the volume of a drop. This may be of great significance for evaluation of an analysis or for mixing of two or more drops in a very specific ratio.

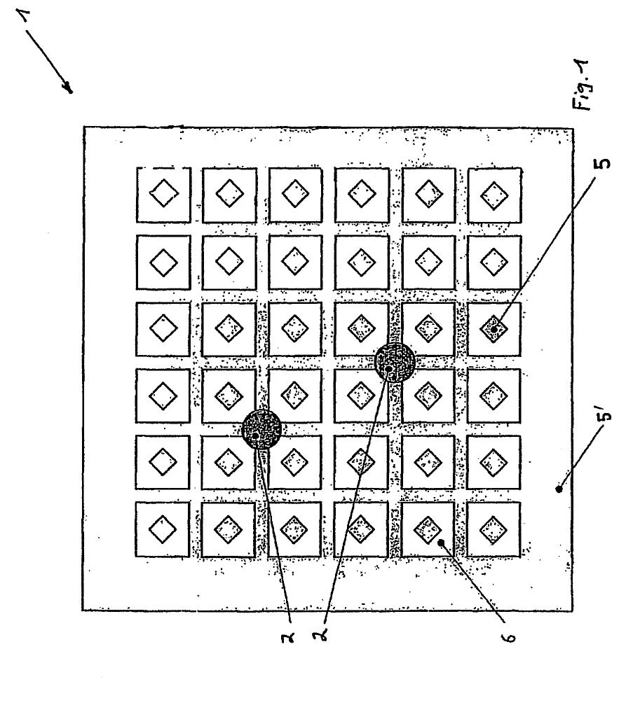

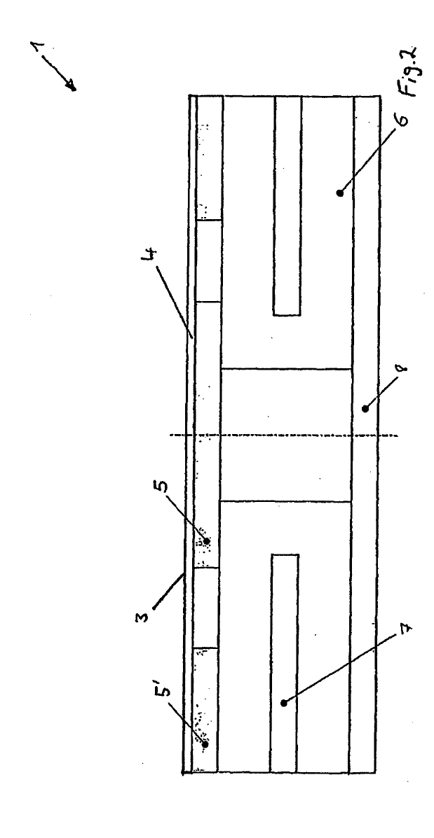

The invention is explained with reference to FIGS. 1 and 2 below. These explanations are given merely by way of example and do not restrict the general concept of the invention.

FIG. 1 is a plan view of the apparatus according to the invention.

FIG. 2 is a section through an electrode in the apparatus according to the invention.

FIG. 1 shows the apparatus 1 according to the invention, which in the present case comprises 36 electrodes 5 and a counter-electrode 5′. The electrodes are arranged in a uniform grid. The spacing of the electrodes is 450 μm, while the edge length of the square electrodes is 150 μm. In the present example, in each case four electrodes 5 are simultaneously actuated with a voltage of 85 V by a computer, such that a fluid drop aligns itself at the vertices of in each case four electrodes. The electrodes are covered by a film 4, which has an ultraphobic surface 3. In the present case, the ultraphobic surface is a surface on which a drop has a contact angle of 174° and a roll-off angle of 3°.

FIG. 2 shows a section through an electrode. The electrode consists of an electrode 5 and a counter-electrode 5′. A dieletric material 6 and shielding 7 are furthermore arranged in the area of the electrode. The electrode comprises connection means 8 in the centre thereof, with which it is connected with a voltage source (not shown), which is controlled by a computer (not shown).

1. A storage plate and/or analysis plate (1) for minuscule fluid drops (2) which comprises an open-top ultraphobic surface (3) and a grid (4) of substantially uniformly distributed electrodes (5) with which an electric field may in each case be generated and which are arranged beneath the ultraphobic surface.

2. A storage plate according to claim 1, characterised in that a voltage source is individually connectable to each electrode.

3. A storage plate according to claim 1, characterised in that two or more electrodes may simultaneously be connected to at least one voltage source.

4. A storage plate according to claim 1, characterised in that a voltage is supplied to at least one electrode which is sufficiently high for a fluid drop to be durably but reversibly locatable above the electrode.

5. A storage plate according to claim 1, characterised in that the electrodes are arranged at a spacing of ≦100 μm and in that the largest dimension thereof is preferably ≦150 μm.

6. A storage plate according to claim 1, characterised in that the ultraphobic surface has a surface topography in which the spatial frequency f of the individual Fourier components and their amplitudes a(f) expressed by the integral S(log(f))=a(f)·f, calculated between the integration limits log(f₁/μm⁻¹)=−3 and log(f₁/μm⁻¹)=3, is at least 0.3, and which consists of ultraphobic polymers or durably ultraphobic materials.

7. A storage plate according to claim 1, characterised in that the ultraphobic surface is a self-adhesive film.

8. A storage plate according to claim 1, characterised in that it comprises a fluid reservoir.

9. A storage plate according to claim 1, characterised in that it comprises a removable lid.

10. A method for setting down fluid drops with an apparatus comprising a storage plate and/or analysis plate (1) for minuscule fluid drops (2) which comprises an open-top ultraphobic surface (3) and a grid (4) of substantially uniformly distributed electrodes (5) with which an electric field may in each case be generated and which are arranged beneath the ultraphobic surface, characterised in that:
an electric field is generated with at least one electrode;
in each case a fluid drop is deposited on the ultraphobic surface; and
the fluid drop is immobilised by the electric field.

11. A method according to claim 10, characterised in that the drop is dispensed by a metering pump onto the ultraphobic surface and is attracted by the electric field.

12. A method according to claim 10, characterised in that two or more fluid drops are set down each at different points on the ultraphobic surface.

13. A method according to claim 1, characterised in that, before or after being set down, the fluid drops are mixed, combined, and/or divided.

14. A method for minimising fluid losses and mass transport phenomena in a drop which is moved and/or stored on a surface, characterised in that a surface energy between the surface and the drop is minimised.

15. A method according to claim 14, characterised in that the drop is stored on an ultraphobic surface.

16. Use of ultraphobic surfaces for reducing fluid losses and mass transport phenomena during storage and analysis of minuscule fluid drops.

17. A method for locating fluid drops with an apparatus comprising a storage plate and/or analysis plate (1) for minuscule fluid drops (2) which comprises an open-top ultraphobic surface (3) and a grid (4) of substantially uniformly distributed electrodes (5) with which an electric field may in each case be generated and which are arranged beneath the ultraphobic surface, characterised in that a electrical voltage between two of the electrodes in a vicinity of a fluid drop is modified periodically, and a change in current and a phase shift between a periodic voltage change and current change is measured.

18. A method for locating fluid drops on a surface, characterised in that light is emitted with at least one light source and a position of the fluid drop is determined on a basis of a reflected portions of the light.

19. A method according to claim 17 further comprising emitting light with at least one light source and determining a position of the fluid drop on the basis of reflected portions of the light.

20. A method according to claim 17, characterised in that the fluid drops are additionally located by an optical microscope.

21. A method for determining the size of a fluid drop with an apparatus comprising a storage plate and/or analysis plate (1) for minuscule fluid drops (2) which comprises an open-top ultraphobic surface (3) and a grid (4) of substantially uniformly distributed electrodes (5) with which an electric field may in each case be generated and which are arranged beneath the ultraphobic surface, characterised in that a electrical voltage between two electrodes in a vicinity of the fluid drop is modified periodically, and a variable change in current and a phase shift between a periodic current change and a voltage change is measured, this being a measure of the size of the drop.

22. A method for determining the size of a fluid drop with a light source, wherein light is emitted with at least one light source and the size of the fluid drop is determined on the basis of reflected portions of the light and knowledge of a precise position of the light source.

23. A method according to claim 21 further comprising emitting light with at least one light source and determining the size of the fluid drop on the basis of reflected portions of the light and knowledge of a precise position of the light source.

24. A method according to claim 21, characterised in that the fluid drops are additionally measured by an optical microscope.

25. Use of a plate (1) for minuscule fluid drops (2) which comprises an open-top ultraphobic surface (3) and a grid (4) of substantially uniformly distributed electrodes (5) with which an electric field may in each case be generated and which are arranged beneath the ultraphobic surface as a storage plate and/or analysis plate.

26. Use according to claim 25, characterised in that a voltage source is individually connectable to each electrode.

27. Use according to claim 25, characterised in that two or more electrodes may simultaneously be connected to at least one voltage source.

28. Use according to claim 25, characterised in that a voltage is supplied to at least one electrode which is sufficiently high for a fluid drop to be durably but reversibly locatable above the electrode.

29. Use according to claim 25, characterised in that the electrodes are arranged at a spacing of ≦100 μm and in that the largest dimension thereof is preferably ≦150 μm.

30. Use according to claim 25, characterised in that the ultraphobic surface has a surface topography in which the spatial frequency f of the individual Fourier components and their amplitudes a(f) expressed by the integral S(log(f))=a(f)·f, calculated between the integration limits log(f₁/μm⁻¹)=−3 and log(f₁/μm⁻¹)=3, is at least 0.3, and which consists of ultraphobic polymers or durably ultraphobic materials.

31. Use according to claim 25, characterised in that the ultraphobic surface is a self-adhesive film.

32. Use according to claim 25, characterised in that it comprises a fluid reservoir.

33. Use according to claim 25, characterised in that it comprises a removable lid.
